(19) United States
(12) Patent Application Publication
(10) Pub. No.: US 2016/0196732 A1
(43) Pub. Date: Jul. 7, 2016

(54) PROXIMITY ALERT SYSTEM

(71) Applicants: Debra Robinson Jones, Riverdale, GA (US); Kasheena TaLon Jones, Greer, SC (US)

(72) Inventors: Debra Robinson Jones, Riverdale, GA (US); Kasheena TaLon Jones, Greer, SC (US)

(21) Appl. No.: 14/980,224

(22) Filed: Dec. 28, 2015

Related U.S. Application Data
(60) Provisional application No. 62/100,554, filed on Jan. 7, 2015.

(51) Int. Cl. G08B 21/02; B60Q 9/00

(52) U.S. Cl. CPC G08B 21/0261; B60Q 9/00

(57) ABSTRACT

A child proximity alarm system comprises a first transceiver configured to be carried by a parent or guardian and a second transceiver configured to be attached to a car seat of a child. The first and second transceivers include a proximity sensor that initiates audio and/or visual alerts on the transceivers when the distance between the transceivers exceeds a pre-programmed range. In order for the alerts to be disabled, the first and second transceivers must be physically joined together.

### CROSS-REFERENCE TO RELATED APPLICATION

This application claims the benefit of priority of U.S. provisional application No. 62/100,554, filed Jan. 7, 2015, the contents of which are herein incorporated by reference.

### BACKGROUND OF THE INVENTION

The present invention relates to monitoring systems and, more particularly, to monitoring systems that provide a proximity alert when a caregiver becomes physically separated from a child, or disabled loved one.

Parents and guardians often have a list full of errands during the day that they need to attend to, while also taking care of an infant, a child, or an elderly or disabled loved on in care. Sometimes, parents and guardians can become preoccupied or distracted with running their errands and traveling from destination to destination, which can cause them to forget that they have left their infant or child is in the backseat of their vehicle.

Infants and children that have been locked in a car for extended periods of time, particularly in the heat, have been linked to serious mental and physical injuries, and even death.

Devices are known that relate to child proximity alert systems. Some devices provide a proximity sensor or transmitter that is adapted to attach to a car seat and a receiver adapted to be carried by a parent or guardian, wherein if the receiver exceeds a pre-determined distance from the transmitter, then an alert is triggered on the receiver. Other devices provide proximity sensor systems that are adapted to trigger audio and/or visual alerts on both a device carried by the user and a second device attached to or integral with a child car seat. However, these devices fail to provide a sensor system, wherein the audio and visual alerts can only be turned off via direction interaction between the transceivers.

As can be seen, there is a need for an alarm system that reminds parents and guardians to remove their infant or child from the backseat of a vehicle, or otherwise to avoid inadvertently leaving the child unattended.

### SUMMARY OF THE INVENTION

In one aspect of the present invention, a proximity alert system comprises:

a first transceiver; and a second transceiver; the first and second transceivers having a proximity sensor operable to detect when the first and second transceivers are separated by a predetermined distance and activate an alarm when so separated. The proximity alert system may further comprise: an alarm silencing means, operable by physical contact between the first and second transceivers.

In other aspects of the invention, the proximity alert system may further comprise a micro controller programmed to key the first and second transceivers as a matched pair. The alarm silencing means may comprise: a coupling defined at a mating end of the first and the second transceiver, the coupling operable to silence the alarm when the mating end of the first and second transceiver are physically coupled to one another. In some embodiments, the coupling may comprise a male prong; and a female receptacle. In other embodiments, the coupling may comprise a magnetic sensor.

In other aspects of the invention, the alarm may comprise an audible alarm. In other embodiments of the invention, the alarm may comprise a visual alarm. The alarm may also comprise one of an audible alarm and a visual alarm activated on each of the first transceiver and the second transceiver.

The proximity alert system may, further comprise an attachment means for attaching the first transceiver to a carrier. The attachment means may comprise one of a ring, a hook, a clasp, and a band.

These and other features, aspects and advantages of the present invention will become better understood with reference to the following drawings, description and claims.

### BRIEF DESCRIPTION OF THE DRAWINGS

FIG. 1 is a perspective view of the invention shown in use.

FIG. 2 is a top perspective view illustrating an embodiment of two proximity devices side by side.

FIG. 3 is a bottom perspective view illustrating the two proximity devices side by side

FIG. 4 is a front view illustrating the two proximity devices side by side.

FIG. 5 is a side view illustrating the two proximity devices side by side.

FIG. 6 is a top view illustrating the two proximity devices side by side.

FIG. 7 is a back view illustrating the two proximity devices side by side.

FIG. 8 is a bottom view illustrating the two proximity devices side by side.

FIG. 9 is a perspective view illustrating the invention attached together (not in use).

FIG. 10 is a section view of the invention taken from 10-10 in FIG. 9

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a parent or caregiver an alert signal when a child or dependent loved one in their care becomes physically separated from them. In a preferred embodiment, the alert can only be deactivated when a device associated with the caregiver is physically joined with a device associated with the child or dependent.

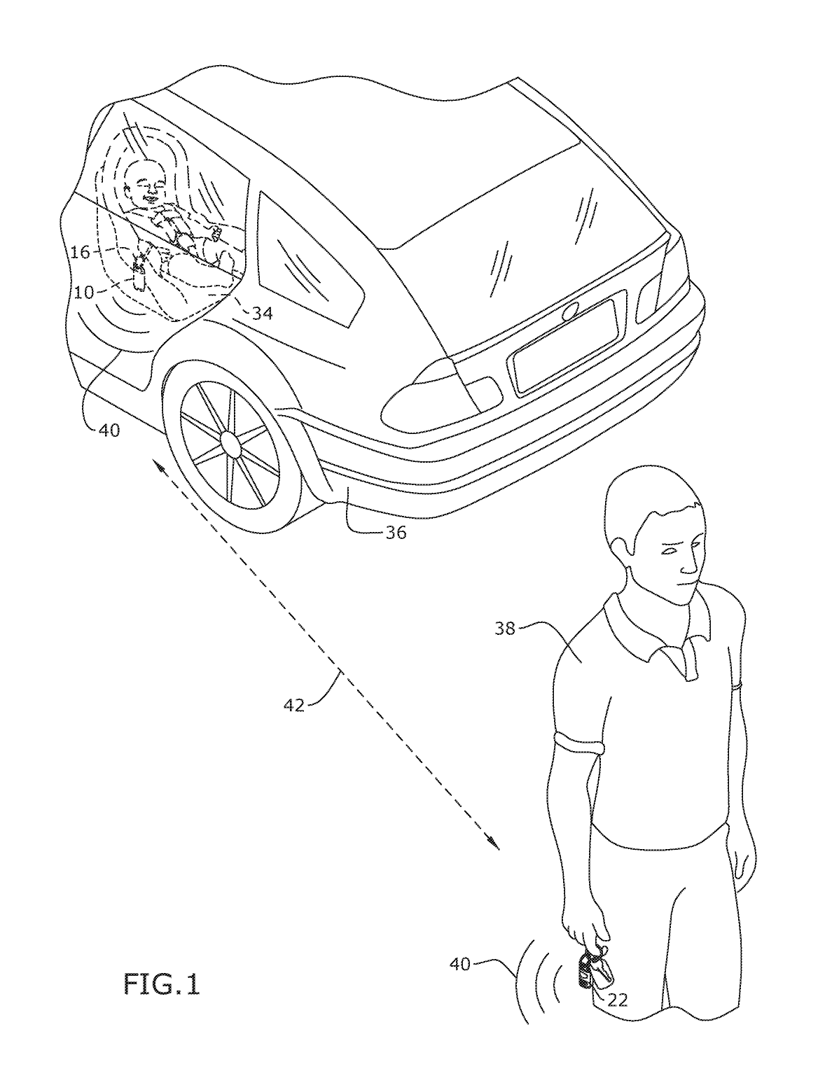

A visual depiction of the alert system of the present invention, shown in use, may be seen in reference to FIG. 1. The alert system includes a first alert transceiver 10 and a second alert transceiver 22. The first alert transceiver 10 may be attached to a child, dependent loved one, or a carrier, such as a car seat, stroller, or wheel chair used to transport them. The second alert transceiver 22 may be carried or worn by a user 38, such as a parent or caregiver, such as on a key chain, purse or the like.

In the scenario depicted, if the user 38 has left the child and car seat 34 in their vehicle 36 with the first alert transceiver 10 attached to the car seat 34, and the user 38, carrying the second alert transceiver 22, becomes physically separated by a predetermined distance 42, an alarm 40 will activate on each of the transceivers 10 & 22 to alert the user 38 that the child has been left unattended. The user 38 may then return to the child and deactivate the alarm and retrieve the child.

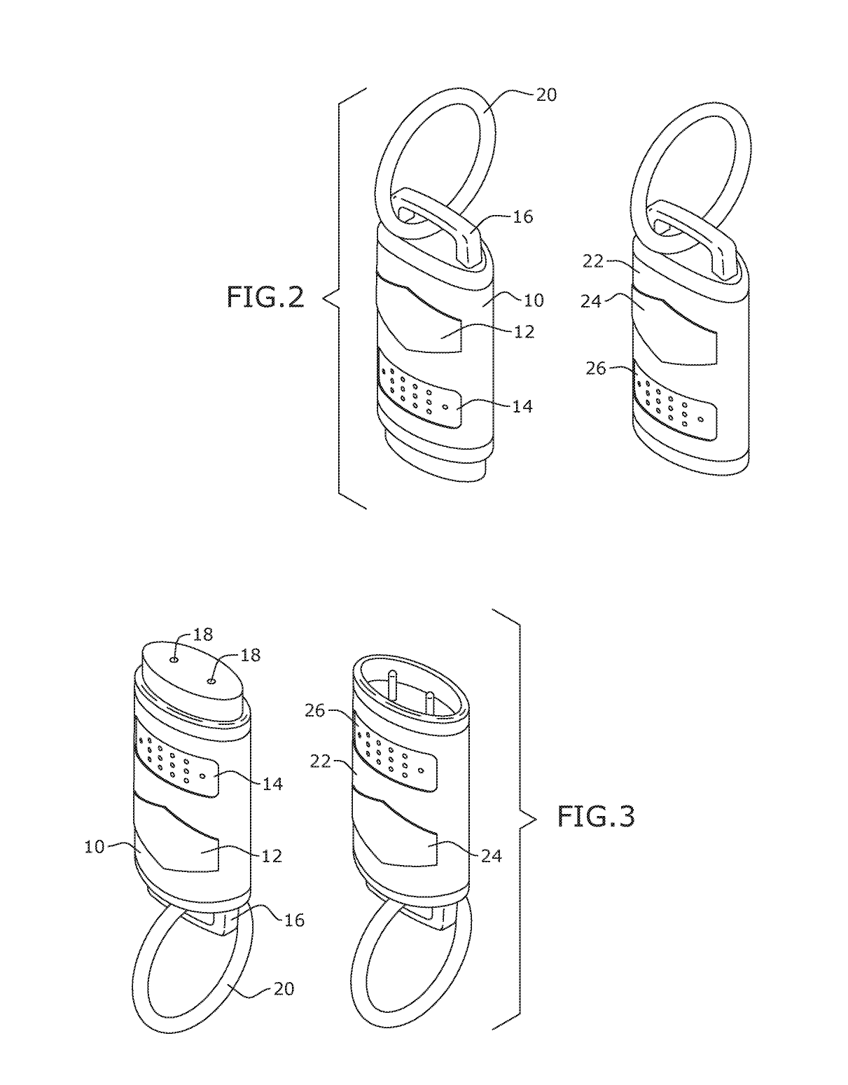

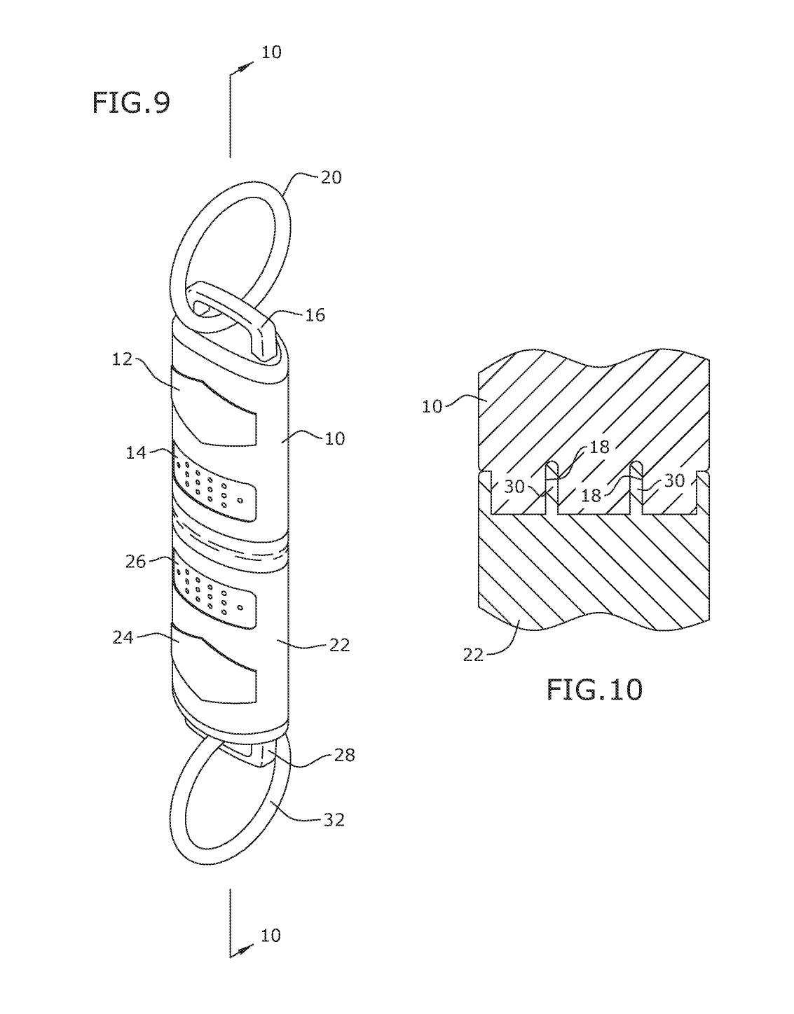

Referring now to FIGS. 2-9, various views of an embodiment of the present invention are shown. The first alert transceiver 10 may include a light signal 12 for presenting a visual alert indication, such as a flashing beacon. The first alert transceiver 10 may also include a speaker area 14 for activation of an audible alarm signal. The first transceiver 10 may also include a handle portion 16 that is adapted to receive a ring, a hook, a clasp, or a band, or other attachment means 20 that may be attached to the child or a child carrier 34.

Similarly, the second alert transceiver 22 may include a light signal 24 for presenting a visual alert indication, such as a flashing beacon. The second alert transceiver 22 may also include a speaker area 26 for activation of an audible alarm signal. The second transceiver 22 may also include a handle portion 28 that is adapted to receive a ring, a hook, a clasp, a band, or other attachment means 32 to attach the second transceiver 22 to the user 38.

The first and second transceivers 10, 22 include proximity sensors that activate an audio and/or a visual alert 40 on the first and second transceivers 10, 22 when the distance between the first and second transceivers exceeds a pre-programmed range 42. To deactivate the audio and/or visual alerts 40 on the first and second transceivers, the first and second transceivers 10, 22 should be in physical contact with one another, and more preferably, physically coupled together.

The transceivers 10 & 22 include a proximity sensor that is configured to transmit a digital signal to a microcontroller upon the satisfaction of a condition, wherein the condition is based upon a user 38 holding the second transceiver 22 exceeding a maximum pre-programmed distance 42 from the first transceiver 10.

The microcontroller is further coupled with an audio alert output means and a visual alert output means, wherein the audio alert output means and visual alert output means are triggered and activated upon the microcontroller receiving a digital signal from the proximity sensor that the first transceiver 10 exceeded the maximum pre-programmed distance 42 from the second transceiver 22. The audio alert output means and visual alert output means can be disabled only when the housings of the first and second transceiver are placed together through a magnetic mechanism or other suitable physical interaction mechanisms.

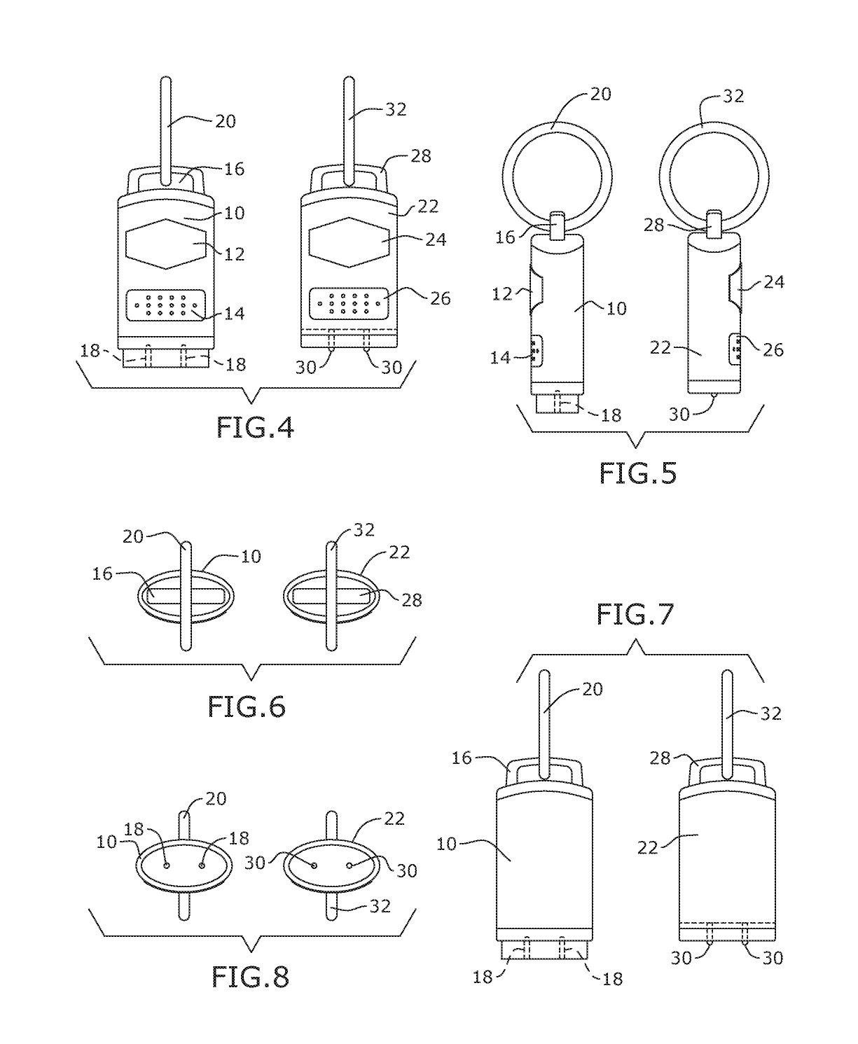

As best seen in reference to FIG. 9, the alarm may be deactivated by physically coupling the first transceiver 10 with the second transceiver 22. As seen in reference to FIGS. 4, 5, and 7-10, the first and the second transceivers 10 & 22 may be configured with a cooperating male prong 30 and a female receptacle 18 defined in a mating end of the respective transceivers. In the embodiment shown, the first transceiver 10 is depicted with a pair of female receptacles 18, while the second transceiver is shown with a pair of male prongs 30. The alarm may be deactivated once the male prong 30 is received in the female receptacle 18, such as by closing an electrical circuit by between the prong 30 and receptacle 18 or via a magnetic sensing of the inter engagement of the devices 10 & 22.

The microcontroller may further be configured such that the first transceiver 10 and the second transceiver 22 are coded such that they are only operable as a keyed pair. That is, as a keyed pair, another transceiver would be inoperable in deactivating either alarm. This feature would be useful in a situation where, a child or loved one were kidnapped or abducted. Similarly, for a caregiver with multiple children, the transceivers 10 & 22 could also be provisioned or configured with a matching keyed code.

It should be understood, of course, that the foregoing relates to exemplary embodiments of the invention and that modifications may be made without departing from the spirit and scope of the invention as set forth in the following claims.

What is claimed is:

1. A proximity alert system, comprising:
a first transceiver; and
a second transceiver;
the first and second transceivers having a proximity sensor operable to detect when the first and second transceivers are separated by a predetermined distance and activate an alarm when so separated.

2. The proximity alert system of claim 1, further comprising:
an alarm silencing means, operable by physical contact between the first and second transceivers.

3. The proximity alert system of claim 2, further comprising:
a micro controller programmed to key the first and second transceivers as a matched pair.

4. The proximity alert system of claim 3, wherein the alarm silencing means comprises:
a coupling defined at a mating end of the first and the second transceiver, the coupling operable to silence the alarm when the mating end of the first and second transceiver are physically coupled to one another.

5. The proximity alert system of claim 4, wherein the coupling comprises:
a male prong; and
a female receptacle.

6. The proximity alert system of claim 4, wherein the coupling comprises:
a magnetic sensor.

7. The proximity alert system of claim 2, wherein the alarm comprises:
an audible alarm.

8. The proximity alert system of claim 2, wherein the alarm comprises:
a visual alarm.

9. The proximity alert system of claim 2, wherein the alarm comprises:
one of an audible alarm and a visual alarm activated on each of the first transceiver and the second transceiver.

10. The proximity alert system of claim 2, further comprising:
attachment means for attaching the first transceiver to a carrier.

11. The proximity alert system of claim 10, wherein the attachment means comprises:
one of a ring, a hook, a clasp, and a band.
